(19) United States
(12) Patent Application Publication
(10) Pub. No.: US 2004/0170157 A1
(43) Pub. Date: Sep. 2, 2004

(54) Apparatus and method for transmitting/receiving preamble in ultra wideband communication system

(75) Inventors: Jae-Yoel Kim, Gunpo-si (KR); Hyoung-Gwan Kim, Seoul (KR); Seong-Ill Park, Seongnam-si (KR); Sun-Yong Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/789,119

(22) Filed: Feb. 27, 2004

(30) Foreign Application Priority Data
Feb. 28, 2003 (KR) 12780/2003

(51) Int. Cl. H04J 3/24; H04B 15/00

(52) U.S. Cl. 370/349; 370/474

(57) ABSTRACT

An ultra wideband communication system, in which first preamble for synchronization is generated using an aperiodic sequence with an aperiodic correlation property, and second preamble for channel estimation is generated using the aperiodic sequence or a periodic sequence with a periodic correlation property. The first and second preambles are multiplexed to be transmitted as a preamble of the UWB communication system.

### PRIORITY

This application claims priority to an application entitled “Apparatus and Method for Transmitting/Receiving Preamble in Ultra Wideband Communication System” filed in the Korean Intellectual Property Office on Feb. 28, 2003 and assigned Serial No. 2003-12780, the contents of which are hereby incorporated by reference.

### BACKGROUND OF THE INVENTION

1. Field of the Invention

The present invention relates to an ultra wideband communication system, and more particularly to an apparatus and a method for dividing and generating preambles for synchronization and channel estimation.

2. Description of the Related Art

Ultra Wideband (“UWB”) is a type of short-distance wireless communication system that is being discussed under 802.15.3a of the IEEE (Institute of Electrical and Electronics Engineers) standards. UWB communication systems are used for high bit-rate wireless communications at a short distance, for example, within a range of up to 10 m. UWB communication systems will be explained in more detail with reference to FIG. 1.

FIG. 1 schematically shows the piconet of a general UWB communication system.

The UWB system is targeted for short-distance wireless communication and applicable to home networks or short range radar systems. A piconet is the basic unit in the UWB communication system.

Referring to FIG. 1, piconet 100 consists of a piconet coordinator (“PNC”) 110 and a plurality of devices (i.e., a first device 120, a second device 130, a third device 140 and a fourth device 150). The PNC 110 transmits beacons, or control signals, to the first to fourth devices 120 to 150 to control the operations of the first to fourth devices 120 to 150. The PNC 110 also transmits data to the first to fourth devices 120 to 150. All devices in the piconet 100 are capable of communicating with each other. The first to fourth devices 120 to 150 can be any devices capable of performing wireless communication, for example, TVs, modems, VTRs and motor vehicles. Such devices for wireless communication create the piconet 100 as shown in FIG. 1. The overall operation of the piconet 100 is controlled by the PNC 110.

UWB permits high-speed transmission of large amounts of data over a relatively broad range of frequency bands, using very low power, at a short range. UWB systems have a capacity proportional to their bandwidth and SNR (Signal to Noise Ratio). UWB systems utilize the signal spreading characteristic that a pulse signal widely spreads in the frequency domain when a very short pulse is transmitted in the time domain. Since trains of short duration pulses are spread to perform communications, UWB systems can shorten the pulse repetition period and lower the transmitted energy density per unit frequency to a level below the energy density for noise propagation. In UWB systems, transmission frequency bands are determined according to the waveforms of pulses. UWB frequencies broaden the spread spectrum and provide a degree of protection against fading even in a place with interference. The UWB systems consume less power because UWB signals have a lower transmitted energy density per unit frequency than noise.

Generally, wireless communication systems can operate only when synchronization between the transmitter and the receiver is achieved. UWB systems also require synchronization between the transmitter and the receiver for wireless communications. In order to achieve such synchronization, a preamble sequence is utilized in a physical layer frame. The physical layer frame in UWB systems has two structures, i.e., a first frame structure applicable when the transmission data rate is 22, 33, 44 or 55 Mb/s and a second frame structure applicable when the data rate is 11 Mb/s. The first frame structure will be explained in more detail with reference to FIG. 2.

FIG. 2 shows a physical layer frame structure of a UWB communication system which is applicable when the data rate is 22, 33, 44 or 55 Mb/s.

Referring to FIG. 2, the physical layer frame for the data rates of 22, 33, 44 and 55 Mb/s consists of a preamble 200, a physical header (“PHY header”) 210, a media access control header (“MAC header”) 220, a header check sequence (“HCS”) 230, a data+frame check sequence (“FCS”) 240, stuff bits (“SB”) 250 and tail symbols (“TS”) 260. The preamble 200 is preferably a QPSK (Quadrature Phase Shift Keying) symbol of length 160, which is used for synchronization during a transmitting/receiving process, carrier offset compensation and equalization of received signals. The PHY header 210, having a 2-octet length, is used to show information, such as a scrambling code, data rate of an MAC frame and data length. One octet is 8-bits long. The MAC header 220, having a 10-octet length, is used to show a frame adjusting signal, a piconet identifier (“PNID”), a destination identifier (“DestID”), a source identifier (“SrcID”), fragmentation control information and stream index information. The HCS 230, having a 2-octet length, is used to detect errors occurring in the PHY header 210 and the MAC header 220. In the data+FCS 240, a data field having a length of 0 to 2048 octets is used to transmit data with its encryption data. As having any length between 0 and 2048 octets, the data field enables transmission of data of varying sizes and encryption data. In the data+FCS 240, the length of the FCS field is 4 octets. The FCS field is used for error detection in the data which is being transmitted. Bits in the SB 250 are a type of dummy bits inserted to generate the data+FCS 240 in a size that is an integer multiple of the symbol size applied to the desired data rate. Of course, when the size of the data+FCS 240 is an integer multiple of the symbol size applied to the desired data rate, the SB 250 needs not be inserted. When the data rate is 11 Mb/s in a UWB communication system, the SB 250 is not inserted into the physical layer frame as will be explained with reference to FIG.3. The TS 260 represents the initial state of a trellis.

The first frame structure of a physical layer for the data rates of 22, 33, 44 and 55 Mb/s has been explained with reference to FIG. 2. FIG. 3 shows a physical layer frame structure of a UWB communication system which is applicable when the data rate is 11 Mb/s.

Referring to FIG. 3, the physical layer frame for the data rate of 11 Mb/s consists of a preamble 300, a PHY header+MAC header+HCS 310, a PHY header+MAC header+HCS 320, a data+FCS 330 and a TS 340. The physical layer frame structure for 11 Mb/s (FIG. 3) is similar to that for the data rates of 22, 33, 44 and 55 Mb/s (FIG. 2). In the physical layer frame for 11 Mb/s, the PHY header, MAC header and HCS are repeatedly inserted to minimize the error rate in the header section. Like the data+FCS 330 and the TS 340, the second PHY header+MAC header+HCS 320 is dealt with as a block to be modulated or demodulated. As explained with reference to FIG. 2, an SB needs not be inserted into the physical layer frame when the size of the data+FCS 330 is an integer multiple of the symbol size applied to the desired data rate, i.e., 11 Mb/s. Therefore, the physical layer frame in FIG. 3 includes no SB.

Hereinafter, an internal structure of a physical layer frame transmitter for transmitting a physical layer frame in a UWB communication system will be explained in detail with reference to FIG. 4. For explanatory convenience, only a physical layer frame transmitter for the data rates of 22, 33, 44 and 55 Mb/s will be explained.

Referring to FIG. 4, data 400 to be transmitted is inputted to a PHY header generator 405, an MAC header generator 410 and a data+FCS generator 415. The PHY header generator 405 generates a PHY header corresponding to the inputted data 400, i.e., a PHY header including information about a scrambling code, data rate of an MAC frame and data length, and outputs the generated PHY header to multiplexers (MUX) 420 and 445. The MAC header generator 410 generates a MAC header corresponding to the inputted data 400, i.e., a MAC header including a frame adjusting signal, a PNID, a DestID, a SrcID, fragmentation control information and stream index information, and outputs the generated MAC header to the multiplexers 420 and 435. The data+FCS generator 415 generates data+FCS corresponding to the inputted data 400 and outputs the generated data+FCS to the multiplexer 435. The data+FCS generator 415 inserts and outputs the generated data and corresponding FCS which is a 32-bit CRC (Cyclic Redundancy Check).

The multiplexer 420 multiplexes signals outputted from the PHY header generator 405 and the MAC header generator 410 to correspond to the physical layer frame structure as shown in FIG. 2 and outputs the multiplexed signals to a HCS generator 430. The HCS generator 430 generates an HCS corresponding to the signals outputted from the multiplexer 420, i.e., the PHY header and the MAC header, and outputs the HCS to the multiplexer 435. The multiplexer 435 multiplexes signals outputted from the HCS generator 430, the MAC header generator 410 and the data+FCS generator 415 to correspond to the physical layer frame structure as shown in FIG. 2 and outputs the multiplexed signals to a scrambler 440. The scrambler 440 scrambles the signals received from the multiplexer 435 using a preset scrambling code and outputs the scrambled signals to the multiplexer 445. The multiplexer 445 multiplexes the signals outputted from the PHY header generator 405 and the scrambler 440 to correspond to the physical layer frame structure as shown in FIG. 2 and outputs the multiplexed signals to the multiplexer 455.

A preamble generator 425 generates a preamble and outputs the generated preamble to the multiplexer 455. A SB generator 450 generates stuff bits for generating the data+FCS in a size that is an integer multiple of the symbol size applied to the desired data rate. The generated stuff bits are outputted to the multiplexer 455. The multiplexer 455 multiplexes the signals outputted from the preamble generator 425, multiplexer 445 and SB generator 450 to correspond to the physical layer frame structure as shown in FIG. 2 and outputs the multiplexed signals to the multiplexer 465. Also, a TS generator 460 generates tail symbols representing the initial trellis state and outputs the TS to the multiplexer 465. The multiplexer 465 multiplexes the signals outputted from the multiplexer 455 and the TS generator 460 to correspond to the physical layer frame structure as shown in FIG. 2 and outputs the multiplexed signals to the air through an antenna.

While FIG. 4 shows a physical layer frame transmitter in a UWB communication system which is applicable for the data rates of 22, 33, 44 and 55 Mb/s, FIG. 5 shows the internal structure of a physical layer frame receiver applicable for the same data rates. The structure of the physical layer frame receiver will be explained in detail with reference to FIG. 5.

Referring to FIG. 5, signals received through the antenna are inputted to a demultiplexer (DEMUX) 500. The demultiplexer 500 demultiplexes the received signals to correspond to the physical layer frame structure as shown in FIG. 2, and outputs the demultiplexed signals to a demultiplexer 505 and a preamble checker 510. To be specific, the demultiplexer 500 demultiplexes the received signals into the preamble and the other fields, i.e., the PHY header, MAC header, HCS, data+FCS, SB and TS, and then outputs the preamble to the preamble checker 510 and the other fields to the demultiplexer 505. Among the fields other than the preamble, SB and TS are not directly related to the present invention. Accordingly, a detailed explanation of these two fields will be omitted for the convenience in explaining the present invention. The preamble checker 510 receives the preamble outputted from the demultiplexer 500, obtains synchronization with the transmitter using the received preamble and performs a channel estimation.

The demultiplexer 505 demultiplexes the signals outputted from the demultiplexer 500 to correspond to the physical layer frame structure as shown in FIG. 2, and outputs the demultiplexed signals to a descrambler 515 and a PHY header analyzer 525. To be specific, the demultiplexer 505 outputs the PHY header among the fields excluding the preamble to the PHY header analyzer 525, while outputting the other fields to the descrambler 515. The PHY header analyzer 525 analyzes the PHY header outputted from the demultiplexer 505 to extract information about a scrambling code, data rate of a MAC frame and data length. The extracted information is outputted to a data recoverer 540. The descrambler 515 descrambles the signals outputted from the demultiplexer 505 using the same scrambling code as used in the physical layer transmitter, and outputs the descrambled signals to a demultiplexer 520. The demultiplexer 520 demultiplexes the signals received from the descrambler 515 to correspond to the physical layer frame structure as shown in FIG. 2, and outputs a MAC header to a MAC header analyzer 530, an HCS to a header error detector 535 and data+FCS to the data recoverer 540.

The MAC header analyzer 530 analyzes the MAC header outputted from the demultiplexer 520 to extract information, such as a frame adjusting signal, a PNID, a DestID, a SrcID, fragmentation control information and stream index information. The extracted information is outputted to the data recoverer 540. The header error detector 535 receives the HCS outputted from the demultiplexer 520 and detects any error in the PHY header and the MAC header. The header error detector 535 outputs the results of error detection to the PHY header analyzer 525 and the MAC header analyzer 530. Upon detecting errors in the PHY header and the MAC header, the header error detector 535 stops processing the physical layer frame. At this time, the data recoverer 540 recovers data+FCS outputted from the demultiplexer 520 using the information outputted from the PHY header analyzer 525 and the MAC header analyzer 530. The data recoverer 540 performs error detection based on the FCS outputted from the demultiplexer 520. If no error is detected in the data, the data recoverer 540 begins recovery of the data. The data 545 recovered by the data recoverer 540 is then recognized as the data transmitted from the transmitter.

Hereinafter, the structure of the preamble generator 425 in the physical layer frame transmitter in FIG. 4 will be explained in detail with reference to FIG. 6.

While showing the same physical layer frame transmitter as shown in FIG. 4, FIG. 6 further details the structure of the preamble generator 425. In order to explain the preamble in more detail, the other signals excluding the preamble, i.e., a PHY header, MAC header, HCS, data+FCS, SB and TS, are collectively termed “physical data.” Referring to FIG. 6, a CAZAC (Constant Amplitude Zero Auto Correlation) sequence generator 600 generates a CAZAC sequence of length 16, and outputs the sequence to a repeater 620 and −1 multiplier 630. In the physical layer frame applicable when the UWB communication system has a data rate of 22, 33, 44 or 55 Mb/s, the preamble code length is 160 symbols. Therefore, the CAZAC sequence of length 16 which has been generated by the CAZAC sequence generator 600 must be repeated. For this purpose, the CAZAC sequence of length 16 is outputted to the repeater 620. The other signals (“physical data 610”) excluding the preamble are inputted to a multiplexer 650.

The repeater 620 repeats the CAZAC sequence of length 16 nine times, and outputs the repeated CAZAC sequence to a multiplexer 640. The −1 multiplier 630 multiplies the CAZAC sequence of length 16 outputted from the CAZAC sequence generator 600 by −1, and outputs the multiplied CAZAC sequence to the multiplexer 640. The multiplexer 640 multiplexes the CAZAC sequence of length 144 outputted from the repeater 620 and the CAZAC sequence of length 16 multiplied by −1 at the −1 multiplier 630. The multiplexed CAZAC sequences are outputted to the multiplexer 650. The multiplexer 640 generates a preamble signal by adding the CAZAC sequence of length 16 multiplied by −1 at the −1 multiplier 630 to the CAZAC sequence of length 144 outputted from the repeater 620. The −1 multiplier 630 multiplies the CAZAC sequence of length 16 outputted from the CAZAC sequence generator 600 by −1 so that the −1 multiplied CAZAC sequence represents the end of preamble delimiter. The multiplexer 650 multiplexes the signals outputted from the multiplexer 640 and the physical data 610 to correspond to the physical layer frame structure as shown in FIG. 2, and outputs the multiplexed signals to a physical layer frame 660.

The structure of the preamble within the physical layer frame of a general UWB communication system outputted from the multiplexer 640 in FIG. 6 will be explained in detail with reference to FIG. 7.

Referring to FIG. 7, the UWB communication system uses a CAZAC sequence as a preamble as explained with reference to FIG. 6. The CAZAC sequence of length 16, which has been outputted from the CAZAC sequence generator 600, is defined as “P0.” The CAZAC sequence P0 is repeated nine times by the repeater 620. P0 to P8 in FIG. 7 are nine identical copies of the CAZAC sequence. E is the CAZAC sequence P0 multiplied by −1 at the −1 multiplier 630. As explained in conjunction with FIG. 6, E represents the end of preamble delimiter. A single preamble is generated by sequential concatenation of P0 to P8 and E. The preamble consisting of P0 to P8 and E is used for synchronization and channel estimation.

The values of elements of a CAZAC sequence having a length 16 will now be explained with reference to the table of FIG. 8.

Referring to FIG. 8, a CAZAC sequence has elements with constant values representing constant amplitudes and possesses a zero autocorrelation property. The zero autocorrelation refers to a property that produces an autocorrelation value corresponding to the sequence value x the amplitude values of the elements when signal transmission and reception are synchronous, while producing a zero autocorrelation when such synchronization is not achieved. Although CAZAC sequences have a good correlation property and are advantageous for channel estimation, their sequence lengths are limited according to the applied modulation methods. For example, a CAZAC sequence has length 2²(=4) when BPSK (Binary Phase Shift Keying) modulation is used, 2⁴(=16) when QPSK modulation is used, and 2⁸(=256) when 8PSK modulation is used.

In wireless communication systems, preambles are generally used to achieve synchronization and channel estimation and confirm the beginning of each frame. In recently developed UWB communication systems, a CAZAC sequence of length 16 is suggested to be used to generate a preamble. However, when QPSK modulation is used, it is difficult to realize hardware of the transmitter and receiver of a UWB system, and QPSK modulation further complicates the hardware of the transmitter and the receiver. Thus, BPSK is suggested as a proper modulation method for UWB systems. BPSK modulation enables easy realization of hardware of the transmitter and the receiver. However, the CAZAC sequence is limited in length due to its properties. As described above, the CAZAC sequence has length 4 when BPSK modulation is used. Although the CAZAC sequence is advantageous in terms of correlation property and channel estimation, it cannot easily achieve synchronization because of its short sequence length when BPSK modulation is used.

It is difficult to achieve synchronization using a CAZAC sequence of length 4 for the following reason.

If a preamble of length 160 is generated by the repetition of a CAZAC sequence of length 4, its correlation value upon synchronization will not be greatly different from the correlation value when synchronization is not achieved. Since it is difficult to determine the exact point of synchronization, the preamble cannot achieve accurate synchronization. There is a growing need for a new preamble which can obtain synchronization without using a CAZAC sequence of length 4.

### SUMMARY OF THE INVENTION

Accordingly, the present invention has been made to solve the above-mentioned problems occurring in the prior art, and one object of the present invention is to provide an apparatus and a method for generating a preamble in an ultra wideband (UWB) communication system.

Another object of the present invention is to provide an apparatus and a method for dividing and generating preambles for synchronization and channel estimation in a UWB communication system.

Still another object of the present invention is to provide an apparatus and a method for generating a preamble using an aperiodic sequence or a periodic sequence in a UWB communication system.

In accordance with a first embodiment for accomplishing the above objects of the present invention, there is provided an apparatus for transmitting a preamble in a UWB communication system, which comprises: a first preamble generator for generating a first preamble for synchronization using an aperiodic sequence having an aperiodic correlation property; a second preamble generator for generating a second preamble for channel estimation using the aperiodic sequence; and a transmitter for multiplexing the first and second preambles and transmitting the multiplexed preambles as a preamble of the UWB communication system.

In accordance with a second embodiment of the present invention, there is provided an apparatus for transmitting a preamble in a UWB communication system, which comprises: a first preamble generator for generating a first preamble for synchronization using an aperiodic sequence with an aperiodic correlation property; a second preamble generator for generating a second preamble for channel estimation using a periodic sequence with a periodic correlation property; and a transmitter for multiplexing the first and second preambles and transmitting the multiplexed preambles as a preamble of the UWB communication system.

In accordance with the first embodiment of the present invention, there is also provided a method for transmitting a preamble in a UWB communication system, which comprises the steps of: generating a first preamble for synchronization using an aperiodic sequence having an aperiodic correlation property; generating a second preamble for channel estimation using the aperiodic sequence; and multiplexing the first and second preambles and transmitting the multiplexed preambles as a preamble of the UWB communication system.

In accordance with the second embodiment of the present invention, there is also provided a method for transmitting a preamble in a UWB communication system, which comprises the steps of: generating a first preamble for synchronization using an aperiodic sequence with an aperiodic correlation property; generating a second preamble for channel estimation using a periodic sequence with a periodic correlation property; and multiplexing the first and second preambles and transmitting the multiplexed preambles as a preamble of the UWB communication system.

In order to accomplish the above objects of the present invention, there is provided an apparatus for receiving a preamble in a UWB communication system, which comprises: a demultiplexer for demultiplexing a received signal and outputting the demultiplexed signal as a first preamble for synchronization, a second preamble for channel estimation and data; a correlation detector for performing synchronization using the first preamble and outputting synchronization information based on performance results; a channel estimator for performing a channel estimation using the second preamble and outputting a channel estimate based on the performance results; and a data recoverer for recovering original data using the synchronization information and the channel estimate.

In order to accomplish the above objects of the present invention, there is also provided a method for receiving a preamble in a UWB communication system, which comprises the steps of: demultiplexing a received signal and outputting the demultiplexed signal as a first preamble for synchronization, a second preamble for channel estimation and data; performing synchronization using the first preamble and outputting synchronization information based on performance results; performing a channel estimation using the second preamble and outputting a channel estimate based on the performance results; and recovering original data using the synchronization information and the channel estimate.

### BRIEF DESCRIPTION OF THE DRAWINGS

The above and other objects, features and advantages of the present invention will be more apparent from the following detailed description taken in conjunction with the accompanying drawings, in which:

FIG. 1 schematically shows the piconet of a general UWB communication system;

FIG. 2 shows a physical layer frame structure of a UWB communication system which is applicable when the data rate is 22, 33, 44 or 55 Mb/s;

FIG. 3 shows a physical layer frame structure of a UWB communication system which is applicable when the data rate is 11 Mb/s;

FIG. 4 schematically shows the internal structure of a physical layer frame transmitter for transmitting the physical layer frame in FIG. 2;

FIG. 5 schematically shows the internal structure of a physical layer frame receiver corresponding to the physical layer frame transmitter in FIG. 4;

FIG. 6 shows the detailed structure of the preamble generator in the physical layer frame transmitter shown in FIG. 4;

FIG. 7 schematically shows the preamble structure within the physical layer frame of a general UWB communication system;

FIG. 8 is a table showing the values of elements of a CAZAC sequence having length 16;

FIG. 9 schematically shows the structure of a physical layer frame of a UWB communication system according to the present invention;

FIG. 10 schematically shows the autocorrelation detection of a periodic sequence;

FIG. 11 schematically shows the autocorrelation detection of an aperiodic sequence;

FIG. 12 shows the internal structure of an ARM sequence generator applicable to the first preamble 930 in FIG. 9;

FIG. 13 schematically shows the internal structure of a physical layer frame transmitter for transmitting the physical layer frame in FIG. 9;

FIG. 14 is a flow chart showing a process of transmitting a physical layer frame using the transmitter in FIG. 13;

FIG. 15 schematically shows the internal structure of a physical layer frame receiver corresponding to the transmitter in FIG. 13; and

FIG. 16 is a flow chart showing a process of receiving a physical layer frame using the receiver in FIG. 15.

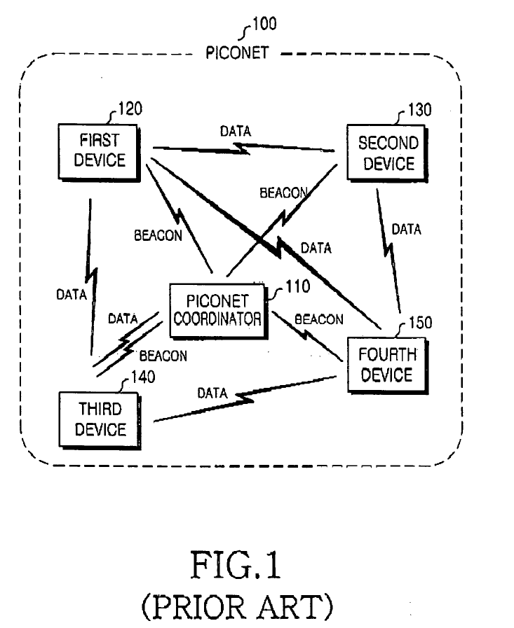

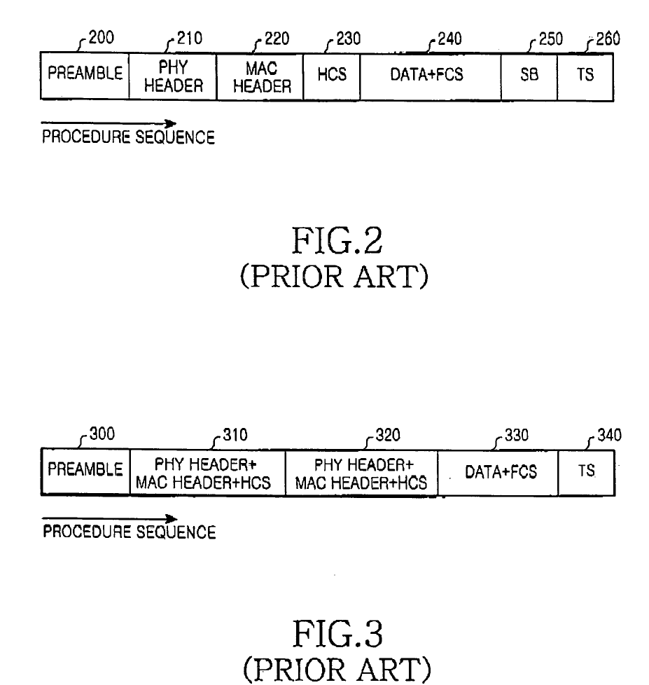

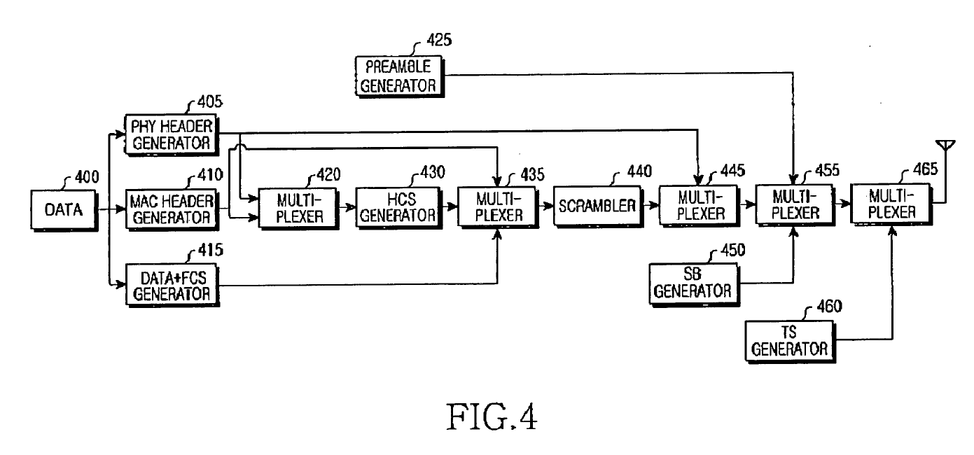

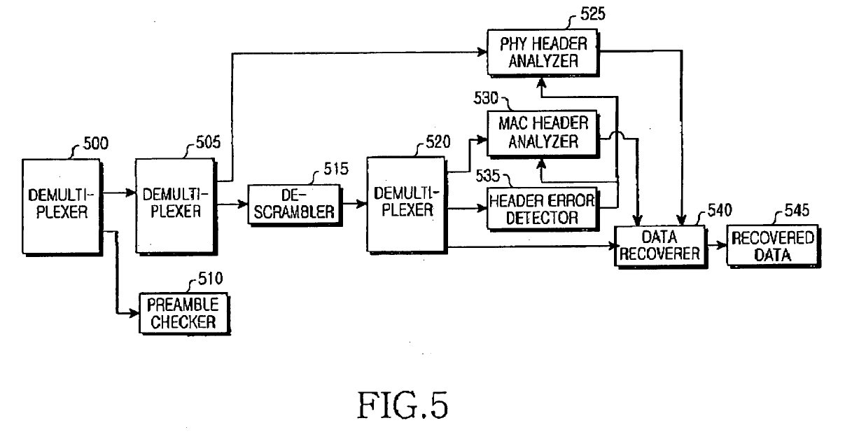

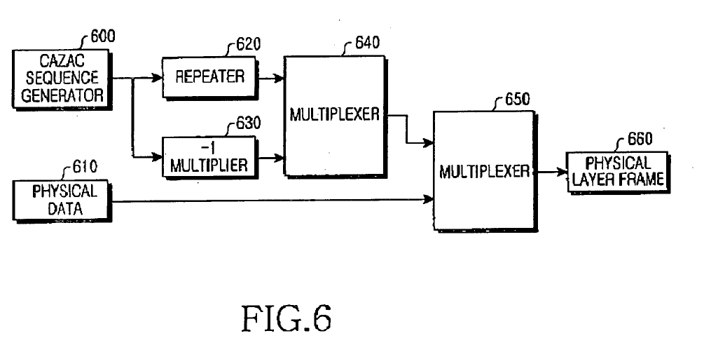

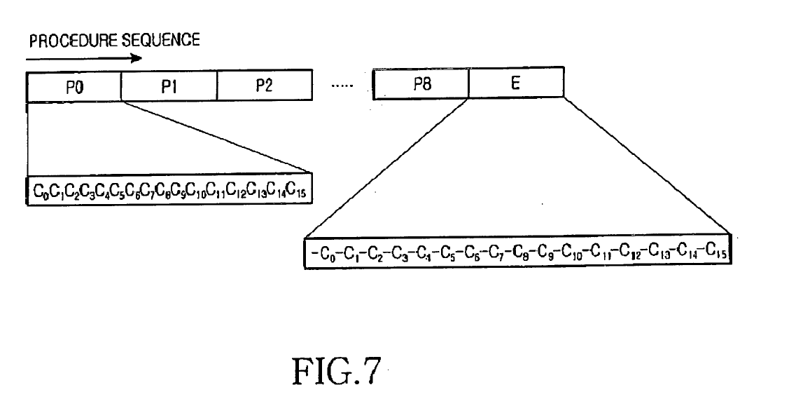

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

In an ultra wideband (UWB) communication system according to the present invention, a preamble is divided into two; one for synchronization and the other for channel estimation. Each preamble is generated to have properties that serve the synchronization or channel estimation purpose. For explanatory convenience, a preamble used for the purpose of synchronization is herein termed “first preamble.” Also, a preamble used for the purpose of channel estimation is termed “second preamble.” In the first embodiment of the present invention, both the first preamble and the second preamble are generated using an aperiodic sequence in the second embodiment of the present invention, the first preamble is generated using an aperiodic sequence, while the second preamble is generated using a periodic sequence. In the preferred embodiments of the present invention, an ARM (Aperiodic Recursive Multiplex) sequence is used as an aperiodic sequence, and a CAZAC (Constant Amplitude Zero Auto Correlation) sequence is used as a periodic sequence. However, any sequence having an aperiodic property, other than the ARM sequence, can be used as an aperiodic sequence. Of course, any sequence having a periodic property, other than the CAZAC sequence, can be used as a periodic sequence. In the first embodiment of the present invention, the ARM sequence is used to generate both the first preamble and the second preamble. In the second embodiment of the present invention, the ARM sequence is used for the first preamble, while the CAZAC sequence is used to generate the second preamble.

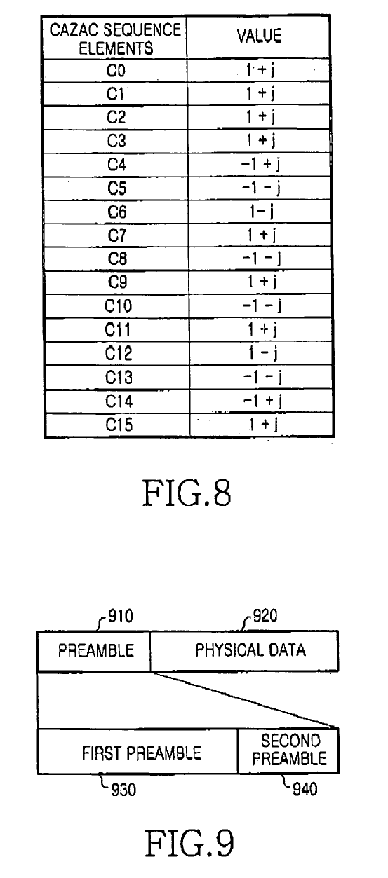

FIG. 9 schematically shows the structure of a physical layer frame of a UWB communication system according to the present invention.

As explained above in connection with the prior art, the physical layer frame has a structure consisting of a preamble, a physical header (“PHY header”), a media access control header (“MAC header”), a header check sequence (“HCS”), a data+frame check sequence (“FSC”), stuff bits (“SB”) and tail symbols (“TS”). This structure of the physical layer frame is applicable when the data rate is 22, 33, 44 or 55 Mb/s. For the data rate of 11 Mb/s, a different structure is applied. The physical layer frame structure applicable for the data rate of 11 Mb/s consists of a preamble, a PHY header+MAC header+HCS, a PHY header+MAC header+HCS, a data+FCS and a TS. For the convenience in explaining the present invention, the other signals excluding the preamble in the physical layer frame are collectively termed “physical data.”

Referring to FIG. 9, the physical layer frame is divided into a preamble 910 and physical data 920. The preamble 910 is composed of a first preamble 930 and a second preamble 940. The first preamble 930 is used to obtain synchronization between the transmitter and the receiver. The second preamble 940 is used for channel estimation. In the first embodiment of the present invention, the first preamble 930 and the second preamble 940 are generated using an aperiodic sequence having a good autocorrelation property. In the second embodiment of the present invention, the first preamble 930 is generated using an aperiodic sequence with a good periodic correlation property, while the second preamble 940 is generated using a periodic sequence with a good channel estimation property. As explained in connection with the prior art, a CAZAC sequence for generating a preamble and QPSK (Quadrature Phase Shift Keying) modulation are suggested in current UWB communication systems. When QPSK modulation is used in a UWB system, it is difficult to realize hardware of the transmitter and receiver of a UWB system, and QPSK modulation further complicates the hardware of the transmitter and the receiver. BPSK is thus considered as a proper modulation method for UWB systems. However, when BPSK modulation is used, the length of the CAZAC sequence is limited to length 4, which makes it difficult to achieve synchronization. To solve such problems, the present invention divides the preamble 910 into the first preamble 930 for synchronization and the second preamble 940 for channel estimation. The first preamble 930 is generated using an ARM sequence which is an aperiodic sequence. The second preamble 940 is generated using an ARM sequence, or a CAZAC sequence which is a kind of periodic sequence.

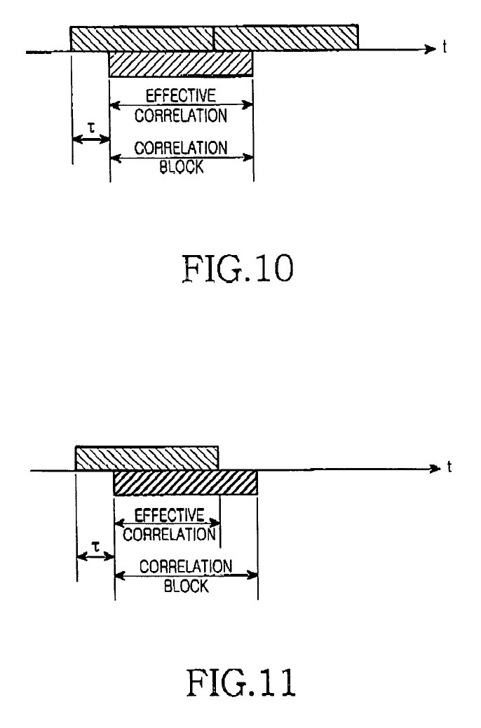

The autocorrelation property of a periodic sequence will be explained with reference to FIG. 10.

FIG. 10 shows the autocorrelation detection of a periodic sequence.

Generally, synchronization of a received signal is determined using an autocorrelation function of the signal. Two schemes are available to calculate correlation for discontinuous transmission. One is to calculate aperiodic correlation, and the other is to calculate periodic correlation. One of these two methods can be selected to calculate the correlation of a received signal according to the properties of the signal. FIG. 10 shows the autocorrelation detection using a periodic correlation calculating scheme.

Referring to FIG. 10, a correlation block is the entire block for measuring the correlation of a received signal. An effective correlation block included in the correlation block is a block that substantially influences the calculation of the autocorrelation between received signals. The autocorrelation function in the effective correlation block is calculated by Equation 1.

$${R}_{xx} ( τ ) = {\sum }_{i = 1}^{N} {x}_{i} {x}_{i + τ}^{*} \qquad Equation 1$$

In this equation, xᵢ represents a received signal. Rₓₓ(τ) represents an autocorrelation function of the received signal xᵢ. The autocorrelation function Rₓₓ(τ) has a value obtained by multiplying values of the signals at times i and i+τ by each other and then averaging the products over a sufficiently large time period T. The higher the autocorrelation is, the better properties a periodic sequence has.

FIG. 11 shows the autocorrelation detection of an aperiodic sequence.

Referring to FIG. 11, a correlation block is the entire block for measuring the correlation of a received signal. An effective correlation block included in the correlation block is a block that substantially influences the calculation of the autocorrelation between received signals. The effective correlation block in FIG. 11 is different from that shown in FIG. 10 to explain a periodic correlation calculation, because aperiodic sequences are not consecutively received. In the aperiodic correlation calculation, a received signal is deemed to be a single wave. When there is a time delay, a block corresponding to the delayed time is excluded from the effective correlation block. As a result, the effective correlation block is reduced, which means that all values of correlation after a time delay are set to zero “0.” The autocorrelation function in the effective correlation block is calculated by-the aperiodic correlation calculation using Equation 2.

$${R}_{xx} ( τ ) = {\sum }_{i = 1}^{N - τ} {x}_{i} {x}_{i + τ}^{*} \qquad Equation 2$$

In this equation, xᵢ represents a received signal. Rₓₓ(τ) represents an autocorrelation function of the received signal xᵢ. The autocorrelation function Rₓₓ(τ) has a value obtained by multiplying values of the signals at times i and i+τ by each other and then averaging the products over a sufficiently large time period T. The lower the autocorrelation is, the better properties an aperiodic sequence has. In other words, good aperiodic sequences have a low autocorrelation when synchronization is not achieved and a high autocorrelation when synchronization is achieved.

As described above, the greatest difference between the periodic correlation calculation and the aperiodic correlation calculation lies in the effective correlation block. When a periodic sequence is used, it is assumed that the same signal is repeatedly received so that the effective correlation block can be continued. Thus, the repeatedly received signal influences the calculation of autocorrelation. However, when an aperiodic sequence is used, one signal is received only once. Subsequently received signals do not influence the calculation of the autocorrelation. For example, the periodic and aperiodic autocortelations obtained using a 4 symbol CAZAC sequence 1101 are as follows. The lag time of a received signal is assumed to be the length of one symbol.

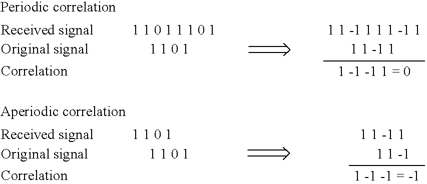

As described above, a big difference between the periodic correlation calculation and the aperiodic correlation calculation is in whether the same sequence is received repeatedly or only once. Generally, a preamble is deemed to be a signal transmitted only once, rather than a signal repeatedly transmitted per physical layer frame. When the receiver fails to normally receive a preamble, it cannot perform any other operation until it receives the next preamble. Based on such properties of a preamble, the present invention uses an aperiodic sequence having an aperiodic autocorrelation function, rather than a periodic sequence having a periodic autocorrelation function.

Although the IEEE 802. 15. 3a proposes a CAZAC sequence of length 16 as a preamble in a UWB communication system, the present invention recommends the use of a 128-bit aperiodic ARM sequence to solve the problems as mentioned above. When a CAZAC sequence of length 4 is used to obtain synchronization, it is repeatedly copied to extend its length. Even if the CAZAC sequence achieves synchronization, its periodic autocorrelation value upon synchronization is not much higher than that when synchronization is not achieved. Thus, it is difficult to determine whether synchronization has actually been achieved. In other words, if a CAZAC sequence of length 4 is repeated to transmit a preamble, the autocorrelation obtained at a point delayed by the CAZAC sequence of length 4 will be different from the autocorrelation obtained upon synchronization by the length of the CAZAC sequence. If BPSK modulation is used in the UWB communication system and the CAZAC sequence of length 4 is repeated to transmit a preamble, the difference between the autocorrelation upon synchronization and that when synchronization is not achieved will be 4 which is not a sufficiently distinctive difference in energy level. Therefore, when the CAZAC sequence is used, it is difficult to exactly detect synchronization.

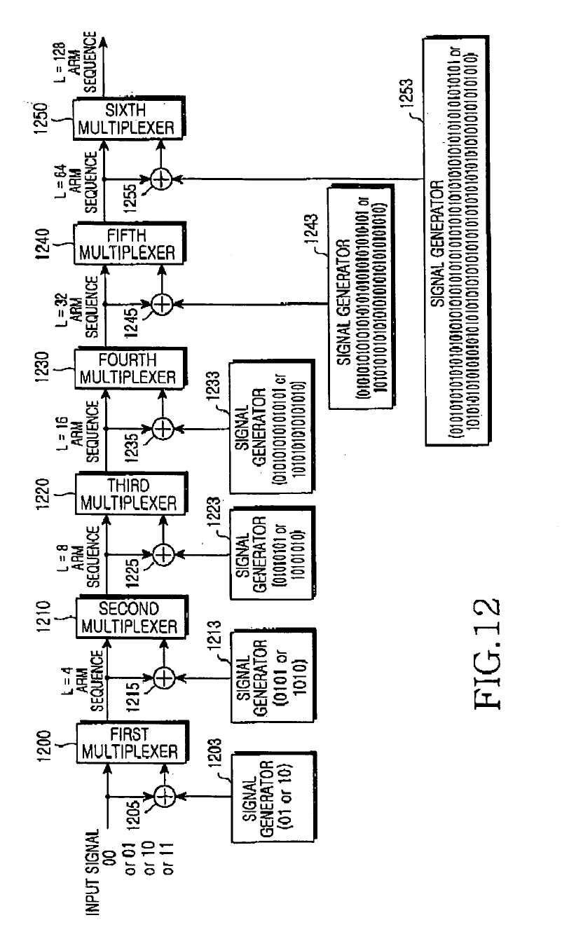

Hereinafter, a device for generating an aperiodic ARM sequence which can be used in the first preamble 930 will be explained with reference to FIG. 12, which shows the internal structure of an ARM sequence generator applicable to the first preamble 930 in FIG. 9.

The ARM sequence generator in FIG. 12 generates an ARM sequence of length 128. Any one of possible combinations of 2 bit numbers (00, 01, 10 and 11) can be inputted as an input signal. The input signal is inputted to a first multiplexer 1200 and an XOR adder 1205. At the same time, a signal generator 1203 generates a binary signal 01 or 10 and outputs the signal to the XOR adder 1205. The XOR adder 1205 performs an exclusive-OR (XOR) on the signal outputted from the signal generator 1203 and the input signal to output them to the first multiplexer 1200. The first multiplexer 1200 alternately time-multiplexes the input signal and the signal outputted from the XOR adder 1205 to generate a 4-bit ARM sequence. The generated 4-bit ARM sequence is then outputted to a second multiplexer 1210 and an XOR adder 1215.

When the 4-bit ARM sequence is inputted to the second multiplexer 1210 from the first multiplexer 1200, a signal generator 1213 generates a signal 0101 or 1010 and outputs the generated signal to the XOR adder 1215. The XOR adder 1215 performs an XOR on the signal outputted from the signal generator 1213 and the 4-bit ARM sequence outputted from the first multiplexer 1200 and outputs them to the second multiplexer 1210. The second multiplexer 1210 alternately time-multiplexes the input signal and the signal outputted from the XOR adder 1215 to generate a 8-bit ARM sequence. The 8-bit ARM sequence is then outputted to a third multiplexer 1220 and an XOR adder 1225.

When the 8-bit ARM sequence is inputted to the third multiplexer 1220 from the second multiplexer 1210, a signal generator 1223 generates a signal 01010101 or 10101010 and outputs the generated signal to the XOR adder 1225. The XOR adder 1225 performs an XOR on the signal outputted from the signal generator 1223 and the 8-bit ARM sequence outputted from the second multiplexer 1210 and outputs them to the third multiplexer 1220. The third multiplexer 1220 alternately time-multiplexes the input signal and the signal outputted from the XOR adder 1225 to generate a 16-bit ARM sequence. The 16-bit ARM sequence is then outputted to a fourth multiplexer 1230 and an XOR adder 1235.

When the 16-bit ARM sequence is inputted to the fourth multiplexer 1230 from the third multiplexer 1220, a signal generator 1233 generates a signal 010101010101010 or 1010101010101010 and outputs the generated signal to the XOR adder 1235. The XOR adder 1235 performs an XOR on the signal outputted from the signal generator 1233 and the 16-bit ARM sequence outputted from the third multiplexer 1220 and outputs them to the fourth multiplexer 1230. The fourth multiplexer 1230 alternately time-multiplexes the input signal and the signal outputted from the XOR adder 1235 to generate a 32-bit ARM sequence. The 32-bit ARM sequence is then outputted to a fifth multiplexer 1240 and an XOR adder 1245.

When the 32-bit ARM sequence is inputted to the fifth multiplexer 1240 from the fourth multiplexer 1230, a signal generator 1243 generates a signal 01010101010101010101010101010101 or 10101010101010101010101010101010 and outputs the generated signal to the XOR adder 1245. The XOR adder 1245 performs an XOR on the signal outputted from the signal generator 1243 and the 32-bit ARM sequence outputted from the fourth multiplexer 1230 and outputs them to the fifth multiplexer 1240. The fifth multiplexer 1240 alternately time-multiplexes the input signal and the signal outputted from the XOR adder 1245 to generate a 64-bit ARM sequence. The 64-bit ARM sequence is then outputted to a sixth multiplexer 1250 and an XOR adder 1255.

When the 64-bit ARM sequence is inputted to the sixth multiplexer 1250 from the fifth multiplexer 1240, a signal generator 1253 generates a signal 0101010101010101010101010101010101010101010101010101010101010101 or 1010101010101010101010101010101010101010101010101010101010101010 and outputs the generated signal to the XOR adder 1255. The XOR adder 1255 performs an XOR on the signal outputted from the signal generator 1253 and the 64-bit ARM sequence outputted from the fifth multiplexer 1240 and outputs them to the sixth multiplexer 1250. The sixth multiplexer 1250 alternately time-multiplexes the input signal and the signal outputted from the XOR adder 1255 to generate a 128-bit ARM sequence which will be used as the first preamble 930. Although FIG. 12 shows how to generate a 128-bit ARM sequence, any ARM sequences having a length corresponding to exponents that are powers of 2, such as 256 or 512 bits, can be generated by expanding the structure in FIG. 12.

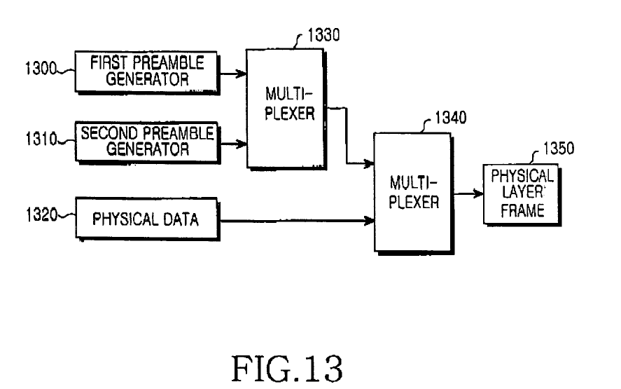

FIG. 13 schematically shows the internal structure of a physical layer frame transmitter for transmitting the physical layer frame in FIG. 9.

In order to explain in detail the preamble of the physical layer frame transmitter in FIG. 3, the other signals excluding the preamble, i.e., a PHY header, MAC header, HCS, data+FCS, SB and TS, are collectively termed “physical data.”

A first preamble generator 1300 generates an ARM sequence of length 128 in the manner as shown in FIG. 12 and outputs the ARM sequence to a multiplexer 1.330. A second preamble generator 1310 generates an ARM sequence of length 32 or repeatedly copies a CAZAC sequence of length 4 eight times. The ARM sequence of length 32 or the repeated CAZAC sequence is outputted to the multiplexer 1330. In the first embodiment using an ARM sequence for the second preamble, the second preamble generator 13 10 generates the ARM sequence of length 32. In the second embodiment using a CAZAC sequence for the second preamble, the second preamble generator 1310 repeatedly generates the CAZAC sequence of length 4 eight times. Since the first preamble has length 128, the length of the second preamble is automatically set to 32. Therefore, when the CAZAC sequence of length 4 is used, it is repeated eight times to generate the second preamble. The multiplexer 1330 multiplexes the first preamble outputted from the first preamble generator 1300 and the second preamble outputted from the second preamble generator 1310 to correspond to the physical layer frame structure as shown in FIG. 9, and outputs the multiplexed preambles to a multiplexer 1340. The physical data 1320 is inputted to the multiplexer 1340. Then, the multiplexer 1340 multiplexes the signal outputted from the multiplexer 1330, i.e., the preambles, and the physical data 1320 to correspond to the physical layer frame structure as shown in FIG. 9. The multiplexed signal and physical data are generated and outputted as a physical layer frame 1350.

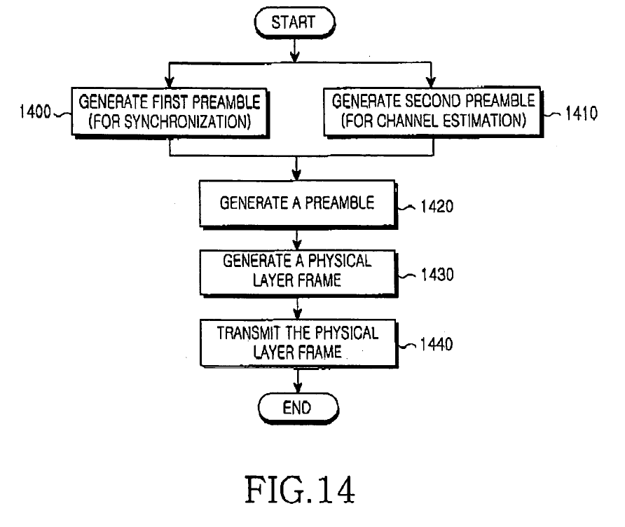

FIG. 14 is a flow chart showing a process of transmitting a physical layer frame using the transmitter in FIG. 13.

Referring to FIG. 14, the physical layer frame transmitter shown in FIG. 13 generates the first preamble for synchronization at step 1400 and proceeds with step 1420. Also, the physical layer frame transmitter generates the second preamble for channel estimation at step 1410 and proceeds with step 1420. At step 1420, the physical layer frame transmitter sequentially concatenates the first preamble and the second preamble to form a single preamble. At step 1430, the physical layer frame transmitter multiplexes the formed preamble and the physical data to correspond to the physical layer frame structure as shown in FIG. 9 in order to generate a physical layer frame. At step 1440, the physical layer frame transmitter transmits the generated physical layer frame to the air and completes the transmission.

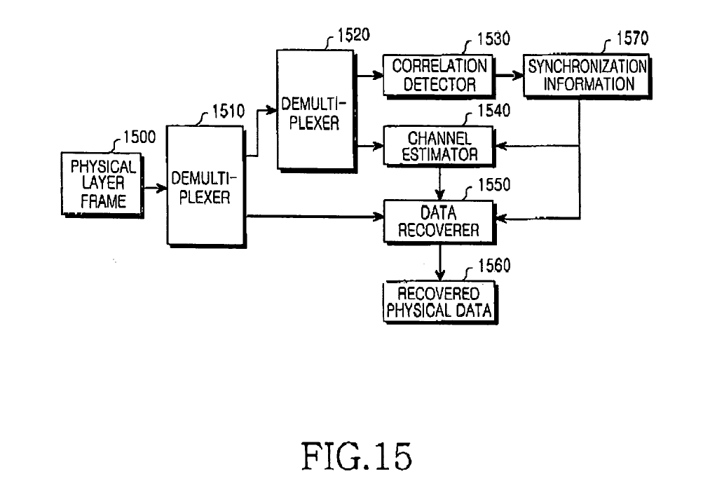

FIG. 15 schematically shows the internal structure of a physical layer frame receiver corresponding to the transmitter in FIG. 13.

Referring to FIG. 15, when the physical layer frame 1500 is received from the air, it is inputted to a demultiplexer (DEMUX) 1510. The demultiplexer 1510 demultiplexes the physical layer frame 1500 to correspond to the physical layer frame structure as shown in FIG. 9, and outputs the preamble to a demultiplexer 1520 and the physical data to a data recoverer 1550. The demultiplexer 1520 demultiplexes the preamble outputted from the demultiplexer 1510 to correspond to the physical layer frame structure as shown in FIG. 9, and outputs the first preamble to a correlation detector 1530 and the second preamble to a channel estimator 1540.

The correlation detector 1530 evaluates the autocorrelation using the first preamble outputted from the demultiplexer 1520. When the evaluated autocorrelation exceeds a preset value of autocorrelation, the correlation detector 1530 determines that synchronization is achieved. The obtained synchronization information 1570 is outputted to the channel estimator 1540 and the data recoverer 1550. The channel estimator 1540 performs a channel estimation using the second preamble outputted from the demultiplexer 1520 and the synchronization information 1570 outputted from the correlation detector 1530, and outputs the results of channel estimation to the data recoverer 1550. The data recoverer 1550 recovers the physical data outputted from the demultiplexer 1510 using the synchronization information 1570 outputted from the correlation detector 1530 and the channel estimation information outputted from the channel estimator 1540, and outputs the recovered original physical data 1560. Of course, when the correlation detector 1530 determines that synchronization has not been achieved, no further operations, i.e., channel estimation and physical data recovery, will be performed.

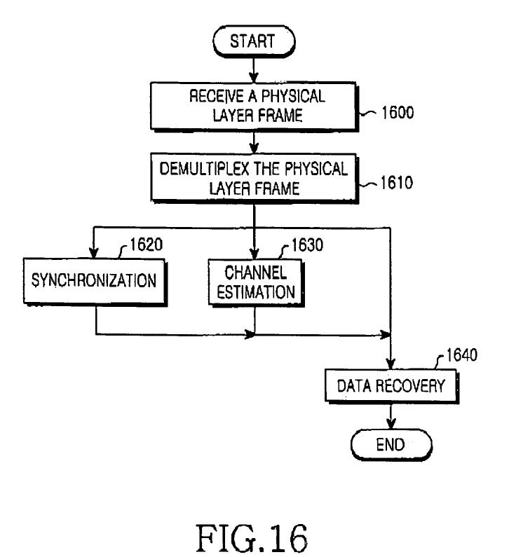

FIG. 16 is a flow chart showing a process of receiving a physical layer frame using the receiver in FIG. 15.

Referring to FIG. 16, upon receiving a physical layer frame from the air at step 1600, the physical layer frame receiver proceeds with step 1610. At step 1610, the physical layer frame receiver demultiplexes the received physical layer frame to correspond to the physical layer frame structure as shown in FIG. 9, and outputs the first preamble, second preamble and physical data. The physical layer frame receiver performs an operation for obtaining synchronization at step 1620 using the first preamble to detect synchronization information, and then proceeds with step 1640. Also, the physical layer frame receiver performs a channel estimation at step 1630 using the second preamble to detect a channel estimate, and then proceeds with step 1640. At step 1640, the physical layer frame receiver recovers the original physical data using the synchronization information and the channel estimate and completes the receiving process.

As explained above, in an ultra wideband (UWB) communication system according to the present invention, a preamble is divided into two; one for synchronization and the other for channel estimation. Each preamble is generated using an aperiodic or periodic sequence to improve the synchronization or channel estimation efficiencies. When BPSK modulation is used in the UWB communication system, CAZAC sequences are not suitable to achieve synchronization. The present invention uses an ARM sequence in a preamble for synchronization and an ARM or CAZAC sequence in a preamble for channel estimation according to the conditions for wireless channel transmission, thereby improving the synchronization and channel estimation efficiencies and increasing the capacity of the UWB system.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. An apparatus for transmitting a preamble in a UWB communication system, which comprises:
a first preamble generator for generating a first preamble for synchronization using an aperiodic sequence with an aperiodic correlation property;
a second preamble generator for generating a second preamble for channel estimation using the aperiodic sequence; and
a transmitter for multiplexing the first and second preambles and transmitting the multiplexed preambles as a preamble of the UWB communication system.

2. The apparatus according to claim 1, wherein said aperiodic sequence is an ARM (Aperiodic Recursive Multiplex) sequence.

3. An apparatus for transmitting a preamble in a UWB communication system, which comprises:
a first preamble generator for generating a first preamble for synchronization using an aperiodic sequence with an aperiodic correlation property;
a second preamble generator for generating a second preamble for channel estimation using a periodic sequence with a periodic correlation property; and
a transmitter for multiplexing the first and second preambles and transmitting the multiplexed preambles as a preamble of the UWB communication system.

4. The apparatus according to claim 3, wherein said aperiodic sequence is an ARM (Aperiodic Recursive Multiplex) sequence.

5. The apparatus according to claim 3, wherein said periodic sequence is a CAZAC (Constant Amplitude Zero Auto Correlation) sequence.

6. An apparatus for receiving a preamble in a UWB communication system, which comprises:
a demultiplexer for demultiplexing a received signal and outputting the demultiplexed signal as a first preamble for synchronization, a second preamble for channel estimation, and data;
a correlation detector for performing synchronization using the first preamble and outputting synchronization information based on performance results;
a channel estimator for performing a channel estimation using the second preamble and outputting a channel estimate based on the performance results; and
a data recoverer for recovering original data using the synchronization information and the channel estimate.

7. The apparatus according to claim 6, wherein said first preamble and second preamble are aperiodic sequences, preferably, ARM (Aperiodic Recursive Multiplex) sequences.

8. The apparatus according to claim 6, wherein said first preamble is an aperiodic sequence, preferably, an ARM (Aperiodic Recursive Multiplex) sequence.

9. The apparatus according to claim 6, wherein said second preamble is a periodic sequence, preferably, a CAZAC (Constant Amplitude Zero Auto Correlation) sequence.

10. A method for transmitting a preamble in a UWB communication system, which comprises the steps of:
generating a first preamble for synchronization using an aperiodic sequence having an aperiodic correlation property;
generating a second preamble for channel estimation using the aperiodic sequence; and
multiplexing the first and second preambles and transmitting the multiplexed preambles as a preamble of the UWB communication system.

11. The method according to claim 10, wherein said aperiodic sequence is an ARM (Aperiodic Recursive Multiplex) sequence.

12. A method for transmitting a preamble in a UWB communication system, which comprises the steps of:
generating a first preamble for synchronization using an aperiodic sequence with an aperiodic correlation property;
generating a second preamble for channel estimation using a periodic sequence with a periodic correlation property; and
multiplexing the first and second preambles and transmitting the multiplexed preambles as a preamble of the UWB communication system.

13. The method according to claim 12, wherein said aperiodic sequence is an ARM (Aperiodic Recursive Multiplex) sequence.

14. The method according to claim 12, wherein said periodic sequence is a CAZAC (Constant Amplitude Zero Auto Correlation) sequence.

15. A method for receiving a preamble in a UWB communication system, which comprises the steps of:
demultiplexing a received signal and outputting the demultiplexed signal as a first preamble for synchronization, a second preamble for channel estimation, and data;
performing synchronization using the first preamble and outputting synchronization information based on performance results;
performing a channel estimation using the second preamble and outputting a channel estimate based on the performance results; and
recovering original data using the synchronization information and the channel estimate.

16. The method according to claim 15, wherein said first preamble and second preamble are aperiodic sequences, preferably, ARM (Aperiodic Recursive Multiplex) sequences.

17. The method according to claim 15, wherein said first preamble is an aperiodic sequence, preferably, an ARM (Aperiodic Recursive Multiplex) sequence.

18. The method according to claim 15, wherein said second preamble is a periodic sequence, preferably, a CAZAC (Constant Amplitude Zero Auto Correlation) sequence.
